(19) United States
(12) Patent Application Publication
(10) Pub. No.: US 2006/0109927 A1
(43) Pub. Date: May 25, 2006

(54) Synchronizer, method of synchronizing signals and MIMO transceiver employing the same

(75) Inventors: David P. Magee, Plano, TX (US); Michael T. DiRenzo, Coppell, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/993,790

(22) Filed: Nov. 19, 2004

(51) Int. Cl. H04L 1/02

(52) U.S. Cl. 375/267

(57) ABSTRACT

The present invention provides a synchronizer for use with a multiple-input, multiple-output (MIMO) transceiver employing multiple individual transceivers. In one embodiment, the synchronizer includes a synthesizing unit coupled to a reference oscillator and configured to generate separately synthesized radio frequency (RF) signals having relative phase differences. Additionally, the synchronizer also includes a synchronizing unit coupled to the synthesizer unit and configured to adjust the relative phase differences of the separately synthesized RF signals to be less than a predetermined difference to provide synchronization of the multiple individual transceivers based on the predetermined difference.

### TECHNICAL FIELD OF THE INVENTION

The present invention is directed, in general, to communication systems and, more specifically, to a synchronizer, a method of synchronizing signals and a MIMO transceiver employing the synchronizer or the method.

### BACKGROUND OF THE INVENTION

Multiple-input, multiple-output (MIMO) communication systems transmit and receive different data symbols concurrently using multiple antennas. MIMO communication systems employ a coordinating collection of single-dimension transmitters to send a vector symbol of information. Correspondingly, a coordinating collection of single-dimension receivers are employed to receive one or more copies of such a transmitted vector of symbol information. MIMO communication systems may employ a MIMO transmitter at one end of a communication path, and a MIMO receiver at the other end if only one-way communication is required. More typically, a MIMO transceiver is employed at each end to allow transmission and reception in both directions.

The MIMO transceiver employs multiple individual wireless transceivers wherein each transceiver typically has a single-dimension transmitter and a single-dimension receiver. It is important to MIMO transceiver throughput data rate and overall general performance that independent synthesizer signals associated with both the multiple individual transmitters and receivers be as uniform in characteristics as possible.

The phase noise associated with an individual wireless transceiver can be determined from the specifications associated with the synthesizer. However, when multiple transceivers are combined to form a MIMO transceiver, the phase noise becomes a multiple dimension problem. The independent synthesizers will typically lock at different times thereby creating an offset in the associated output frequencies. Additionally, each synthesizer will have bounds for the phase noise that when combined with the different lock times will cause the RF signals to add both constructively and destructively depending on the relative phase of each synthesizer.

MIMO preamble design is one area where this effect is important because the preambles involve concurrent transmission of the same symbol using multiple transceivers. Therefore, relative phase behavior between various transmitters and receivers of the MIMO transceiver reduces the throughput data rate and lowers the overall general performance of the MIMO transceiver.

Accordingly, what is needed in the art is a way to enhance the performance of multiple synthesizers employed in a MIMO transceiver.

### SUMMARY OF THE INVENTION

To address the above-discussed deficiencies of the prior art, the present invention provides a synchronizer for use with a multiple-input, multiple-output (MIMO) transceiver employing multiple individual transceivers. In one embodiment, the synchronizer includes a synthesizing unit coupled to a reference oscillator and configured to generate separately synthesized radio frequency (RF) signals having relative phase differences. Additionally, the synchronizer also includes a synchronizing unit coupled to the synthesizer unit and configured to adjust the relative phase differences of the separately synthesized RF signals to be less than a predetermined difference to provide synchronization of the multiple individual transceivers based on the predetermined difference.

In another aspect, the present invention provides a method of synchronizing signals for use with a multiple-input, multiple-output (MIMO) transceiver employing multiple individual transceivers. The method includes generating separately synthesized radio frequency (RF) signals having relative phase differences and also includes adjusting the relative phase differences of the separately synthesized RF signals to be less than a predetermined difference to provide synchronization of the multiple individual transceivers based on the predetermined difference.

The present invention also provides, in yet another aspect, a multiple-input, multiple-output (MIMO) transceiver for use with multiple concurrent transmissions. The MIMO transceiver includes a first individual transceiver coupled to a first antenna and a second individual transceiver coupled to a second antenna. The MIMO transceiver also includes a synchronizer, coupled to the first and second individual transceivers, having a synthesizing unit, coupled to a reference oscillator, that generates separately synthesized radio frequency (RF) signals having relative phase differences. The synchronizer also has a synchronizing unit, coupled to the synthesizer unit, that adjusts the relative phase differences of the separately synthesized RF signals to be less than a predetermined difference to provide synchronization of the first and second individual transceivers based on the predetermined difference.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a diagram of an embodiment of a multiple-input, multiple-output (MIMO) transceiver constructed in accordance with the principles of the present invention;

FIG. 2 illustrates a diagram of a portion of a MIMO transceiver employing an embodiment of a synchronizer constructed in accordance with the principles of the present invention; and

FIG. 3 illustrates a flow diagram of an embodiment of a method of synchronizing signals carried out in accordance with the principles of the present invention.

### DETAILED DESCRIPTION

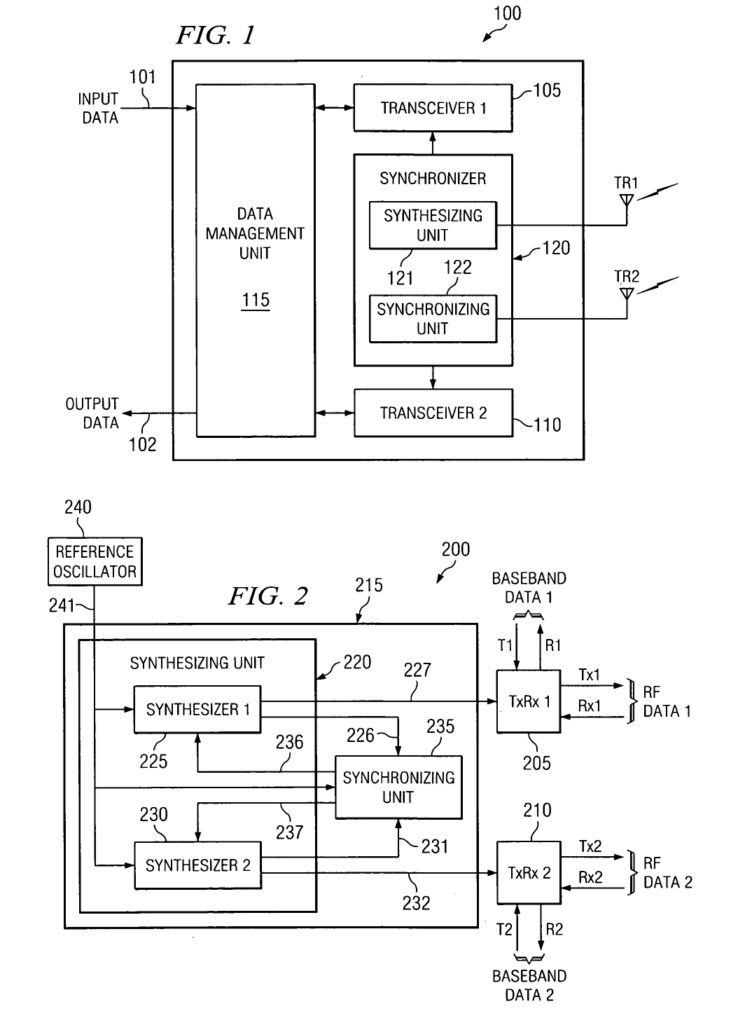

Referring initially to FIG. 1, illustrated is a diagram of an embodiment of a multiple-input, multiple-output (MIMO) transceiver, generally designated 100, constructed in accordance with the principles of the present invention. The MIMO transceiver 100 includes a first individual transceiver 105 coupled to a first antenna TR1 and a second individual transceiver 110 coupled to a second antenna TR2. The MIMO transceiver 100 also includes a data management unit 115 and a synchronizer 120, having a synthesizing unit 121 and a synchronizing unit 122, coupled to the first and second transceivers 105, 110. The data management unit 115 employs a data input 101 and a data output 102.

In the illustrated embodiment, each of the first and second individual transceivers 105, 110 contain first and second transmit systems and first and second receive systems, which are respectively coupled to the first and second antennas TR1, TR2. Each of these transmit and receive systems are employed for MIMO transmissions and receptions. The data management unit 115 coordinates the input data 101 for MIMO transmission and provides the data output 102 for MIMO reception. The synchronizer 120 is employed by the first and second transmit systems to allow modulation of the input data 101 for the MIMO transmission. Similarly, the first and second receive systems employ the synchronizer 120 to allow demodulation of the MIMO reception and provide the output data 102.

The quality of both the MIMO transmission and reception depends on the ability of the synchronizer 120 to provide signals to the first and second individual transceivers 105, 110 that are as nearly the same as possible. The synthesizing unit 121 employs first and second synthesizers that are substantially equal and coupled to a common reference oscillator. When unsynchronized, each of the first and second synthesizers is configured to generate separately synthesized radio frequency (RF) signals.

These RF signals operate at about the same nominal RF frequency although the first and second synthesizers 225, 230 may have different disturbance profiles that would affect this. Furthermore, the first and second synthesizers typically will not lock at the same time thereby creating a relative phase between the two transmit paths even though each RF frequency is correct. This effect becomes worse as the number of transmit paths increases.

The synchronizing unit 122 is coupled to the synthesizer unit 121 and adjusts the relative phase differences of the separately synthesized RF signals to be less than a predetermined phase difference. This action provides an improved synchronization of the otherwise independent operation of the first and second synthesizers, and therefore, an improved synchronization of the first and second individual transceivers 105, 110 based on the predetermined phase difference achieved.

Turning now to FIG. 2, illustrated is a diagram of a portion of a MIMO transceiver, generally designated 200, employing an embodiment of a synchronizer constructed in accordance with the principles of the present invention. The MIMO transceiver portion 200 includes first and second individual transceivers 205, 210 and a synchronizer 215 coupled to a reference oscillator 240. The first individual transceiver 205 includes a first baseband data input T1 and a first RF transmit output Tx1. The first individual transceiver 205 also includes a first RF receive input Rx1 and a first baseband data output R1. Similarly, the second individual transceiver 210 includes a second baseband data input T2 and a second RF transmit output Tx2. The second individual transceiver 210 also includes a second RF receive input Rx2 and a second baseband data output R2.

The synchronizer 215 includes a synthesizing unit 220 and a synchronizing unit 235. The synthesizing unit 220 includes first and second synthesizers 225, 230 that are coupled to the synchronizing unit 235 by first and second synthesizing signals 226, 231 and first and second synchronizing signals 236, 237. The first and second synthesizers 225, 230 provide first and second synthesizer output signals 227, 232 to the first and second individual transceivers 205, 210. A reference oscillator signal 241 is provided to the first and second synthesizers 225, 230 and the synchronizing unit 235, as shown.

The first and second individual transceivers 205, 210 employ the first and second synthesizer output signals 227, 232 to transform first and second groups of baseband data into transmit RF data for transmission by the first and second RF transmit outputs Tx1, Tx2, respectively. Analogously, the first and second individual transceivers 205, 210 employ the first and second synthesizer output signals 227, 232 to provide first and second groups of baseband data from receive RF data on the first and second RF receive inputs Rx1, Rx2, respectively.

The first and second synthesizer output signals 227, 232 are synthesized signals from the synthesizing unit 220 that have been synchronized to a predetermined degree by interaction with the synchronizing unit 235. As stated earlier, the first and second synthesizers 225, 230 may provide separately synthesized RF signals of a same nominal frequency. However, relative phase differences between the separately synthesized RF signals gives rise to MIMO transceiving problems. The synchronizing unit 235 adjusts these relative phase differences to be less than a predetermined phase difference thereby allowing the first and second individual transceivers 205, 210 to operate more effectively as a MIMO transceiver.

As shown in FIG. 2, the first and second synthesizers 225, 230 and the synchronizing unit 235 are coupled to the reference oscillator 240. This allows the synchronizing unit 235 to employ logic that determines a same number of counts or cycles of the reference oscillator 240 that may be employed to synchronize the first and second synthesizers 225, 230. This adjusted phase condition allows them to behave in the same manner and lock at the same time so that the relative phase difference between the first and second synthesizer output signals 227, 232 is substantially reduced. The first and second synchronizing signals 336, 237 are employed to convey this condition to the first and second synthesizers 225, 230, in the illustrated embodiment.

Each of the first and second synthesizers 225, 230 can then pass relevant information to the synchronizing unit 235 employing the first and second synthesizing signals 226, 231. For the adjusted phase condition discussed above, the relevant information may include a decimated form of synthesized RF frequencies (first and second synthesizer output signals 227, 232) so that at least one relative error term associated with the first and second synthesizers 225, 230 may be computed. An alternative approach is for the relevant information to be a decimated form of synthesized intermediate frequency (IF) signals so that at least one relative error term associated with the first and second synthesizers 225, 230 may be captured. This relative error term may be used to adjust the phase of each of the first and second synthesizers 225, 230 so that the RF signals generated by each can be properly aligned.

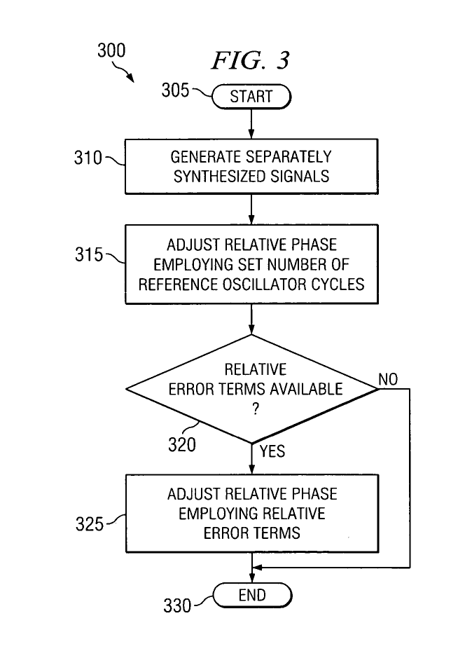

Turning now to FIG. 3, illustrated is a flow diagram of an embodiment of a method of synchronizing signals, generally designated 300, carried out in accordance with the principles of the present invention. The method 300 starts in a step 305 with the intent to synchronize signals for use with a MIMO transceiver having a multiplicity of individual transceivers. A separately synthesized RF signal is generated for each of the multiplicity of individual transceivers based on a common reference oscillator and having a same nominal RF frequency, in a step 310. The separately synthesized RF signals generated in the step 310 have relative phase differences that would cause a performance degradation of the MIMO transceiver.

Then, in a step 315, each of the relative phase differences are adjusted by employing a same number of reference oscillator cycles to lock separate synthesizers thereby allowing a predetermined difference to be established in the relative phases between them. In a decisional step 320, it is determined if a relative error term is available that is associated with each of the separate synthesizers based on a decimated form of the nominal RF frequency.

If the relative error terms are available, the relative error terms may be employed to further adjust the relative phase differences for closer alignment based on an improved predetermined phase difference, in a step 325. Then the method 300 ends in a step 330. If the relative error terms are not available in the decisional step 320, the method 300 also ends in the step 330. These adjustments provide synchronization of the multiple individual transceivers based on the predetermined phase difference employed.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps are not limitations of the present invention.

In summary, embodiments of the present invention employing a synchronizer, a method of synchronizing signals and a MIMO transceiver employing the synchronizer or method. Advantages include providing a synchronizing mechanism between multiple synthesizers to minimize the phase offset between RF frequencies and leveraging or improving existing MIMO transceivers with a minimal amount of synchronization modification. Additionally, time optimal preamble designs such as frequency-switched designs for MIMO communication systems may be employed thereby allowing higher data throughput.

Although the embodiments presented employ MIMO transceivers, one skilled in the pertinent art will understand that the principles of the present invention may be applied separately to MIMO transmitters or MIMO receivers. Additionally, though not specifically illustrated, the principles of the present invention may also be applied to intermediate frequency (IF) signals that may be employed in MIMO communication systems.

Although the present invention has been described in detail, those skilled in the art should understand that they can make various changes, substitutions and alterations herein without departing from the spirit and scope of the invention in its broadest form.

What is claimed is:

1. A synchronizer for use with a multiple-input, multiple-output (MIMO) transceiver employing multiple individual transceivers, comprising:
a synthesizing unit coupled to a reference oscillator and configured to generate separately synthesized radio frequency (RF) signals having relative phase differences; and
a synchronizing unit coupled to said synthesizer unit and configured to adjust said relative phase differences of said separately synthesized RF signals to be less than a predetermined difference to provide synchronization of said multiple individual transceivers based on said predetermined difference.

2. The synchronizer as recited in claim 1 wherein said synthesizing unit provides said separately synthesized RF signals at a same nominal frequency.

3. The synchronizer as recited in claim 1 wherein said synchronizing unit employs a set number of reference oscillator cycles to adjust said relative phase differences to be less than said predetermined difference.

4. The synchronizer as recited in claim 1 wherein said synchronizing unit employs relative error terms from said synthesizing unit to adjust said relative phase differences to be less than said predetermined difference.

5. The synchronizer as recited in claim 1 wherein said synchronization of said multiple individual transceivers is employed in conjunction with baseband data to generate transmit RF data.

6. The synchronizer as recited in claim 1 wherein said synchronization of said multiple individual transceivers is employed in conjunction with receive RF data to generate baseband data.

7. The synchronizer as recited in claim 1 further configured to be employed with an intermediate frequency (IF) signal.

8. A method of synchronizing signals for use with a multiple-input, multiple-output (MIMO) transceiver employing multiple individual transceivers, comprising:
generating separately synthesized radio frequency (RF) signals having relative phase differences; and
adjusting said relative phase differences of said separately synthesized RF signals to be less than a predetermined difference to provide synchronization of said multiple individual transceivers based on said predetermined difference.

9. The method as recited in claim 8 wherein said generating provides said separately synthesized RF signals at a same nominal frequency.

10. The method as recited in claim 8 wherein said adjusting employs a set number of reference oscillator cycles.

11. The method as recited in claim 8 wherein said adjusting employs relative error terms from said generating.

12. The method as recited in claim 8 wherein said synchronization of said multiple individual transceivers is employed in conjunction with baseband data to generate transmit RF data.

13. The method as recited in claim 8 wherein said synchronization of said multiple individual transceivers is employed in conjunction with receive RF data to generate baseband data.

14. The method as recited in claim 8 further employing an intermediate frequency (IF) signal.

15. A multiple-input, multiple-output (MIMO) transceiver for use with multiple concurrent transmissions, comprising:
a first individual transceiver coupled to a first antenna;
a second individual transceiver coupled to a second antenna; and
a synchronizer, coupled to said first and second individual transceivers, including:
a synthesizing unit, coupled to a reference oscillator, that generates separately synthesized radio frequency (RF) signals having relative phase differences; and
a synchronizing unit, coupled to said synthesizer unit, that adjusts said relative phase differences of said separately synthesized RF signals to be less than a predetermined difference to provide synchronization of said first and second individual transceivers based on said predetermined difference.

16. The MIMO transceiver as recited in claim 15 wherein said synthesizing unit provides said separately synthesized RF signals at a same nominal frequency.

17. The MIMO transceiver as recited in claim 15 wherein said synchronizing unit employs a set number of reference oscillator cycles to adjust said relative phase differences to be less than said predetermined difference.

18. The MIMO transceiver as recited in claim 15 wherein said synchronizing unit employs relative error terms from said synthesizing unit to adjust said relative phase differences to be less than said predetermined difference.

19. The MIMO transceiver as recited in claim 15 wherein said synchronization of said first and second individual transceivers is employed in conjunction with baseband data to generate transmit RF data.

20. The MIMO transceiver as recited in claim 15 wherein said synchronization of said first and second individual transceivers is employed in conjunction with receive RF data to generate baseband data.

21. The MIMO transceiver as recited in claim 15 wherein said synchronizer is further employed with an intermediate frequency (IF) signal.
